(19) United States
(12) Patent Application Publication
(10) Pub. No.: US 2015/0271743 A1
(43) Pub. Date: Sep. 24, 2015

(54) Small Cell Discovery

(71) Applicant: NOKIA SOLUTIONS AND NETWORKS OY, Espoo (FI)

(72) Inventors: Yong Teng, Beijing (CN); Kari Veikko Horneman, Oulu (FI); Bin Chen, Wuhan (CN); Jiang Wang, Shanghai (CN); Jing Xu, Shanghai (CN)

(73) Assignee: NOKIA SOLUTIONS AND NETWORKS OY, Espoo (FI)

(21) Appl. No.: 14/434,131

(22) PCT Filed: Oct. 8, 2012
(86) PCT No.: PCT/CN2012/082558

§ 371 Date: Apr. 8, 2015

(51) Int. Cl. H04W 48/16; H04W 72/04; H04W 48/14

(52) U.S. Cl. CPC H04W 48/16; H04W 48/14; H04W 72/0413; H04W 88/08

(57) ABSTRACT

There is provided a method, including detecting, by a network node of a local area cell whether or not there is at least one user terminal connected to a macro cell present in a coverage area of the local area cell; upon detecting the presence of the at least one user terminal, causing a transmission of a request message to an associated cell, wherein the request message includes a resource allocation request for a discovery signal transmission on an operating frequency of the macro cell causing a reception of a response message from the associated cell, wherein the response message includes an indication of allocated resources for the discovery signal transmission; and causing a transmission of the discovery signal on the indicated resources in order to allow the at least one user terminal in the cover-age area of the local area cell to detect the discovery signal transmission.

### FIELD

The invention relates generally to mobile communication networks. More particularly, the invention relates to discovery of small cells coexisting within a surrounding macro cell.

### BACKGROUND

Local area or small cells are typically mobile communication base stations, such as pico cells or femtocells, which may significantly improve the user experience in an economical way. The small cells are frequently deployed with macro cells in an overlapped way. The small cells may provide additional capacity and coverage in homes and offices. However, discovery of such small cells may be cumbersome.

### BRIEF DESCRIPTION OF THE INVENTION

According to an aspect of the invention, there are provided methods as specified in claims 1 and 10.

According to an aspect of the invention, there are provided apparatuses as specified in claims 14, 23, and 27.

According to an aspect of the invention, there is provided a computer program product as specified in claim 28.

According to an aspect of the invention, there is provided a computer-readable distribution medium carrying the above-mentioned computer program product.

According to an aspect of the invention, there is provided an apparatus comprising processing means configured to cause the apparatus to perform any of the embodiments as described in the appended claims.

According to an aspect of the invention, there is provided an apparatus comprising a processing system configured to cause the apparatus to perform any of the embodiments as described in the appended claims.

According to an aspect of the invention, there is provided an apparatus comprising means for performing any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents an example communication network to which the embodiments are applicable to;

FIGS. 2A and 2B show transmission of a discovery signal, according to some embodiments;

FIGS. 3 and 4 show methods according to some embodiments;

FIG. 5 illustrates a signaling flow diagram according to an embodiment;

FIG. 6 presents suspending the discovery signal transmission, according to some embodiments; and

FIGS. 7 and 8 depict apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

The embodiments of the invention are applicable to a plurality of communication networks regardless of the applied radio access technology. For example, at least one of the following radio access technologies (RATs) may be applied: World-wide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), LTE, and/or LTE-A. The present embodiments are not, however, limited to these protocols. Typically the communication network comprises base stations, such as a node B (NB) or an evolved node B (eNB), capable of controlling radio communication and managing radio resources within the cell. Further, the eNB may establish a connection with a user equipment/(UE) such as a mobile user terminal (UT) or any other apparatus capable of operating in a mobile communication network.

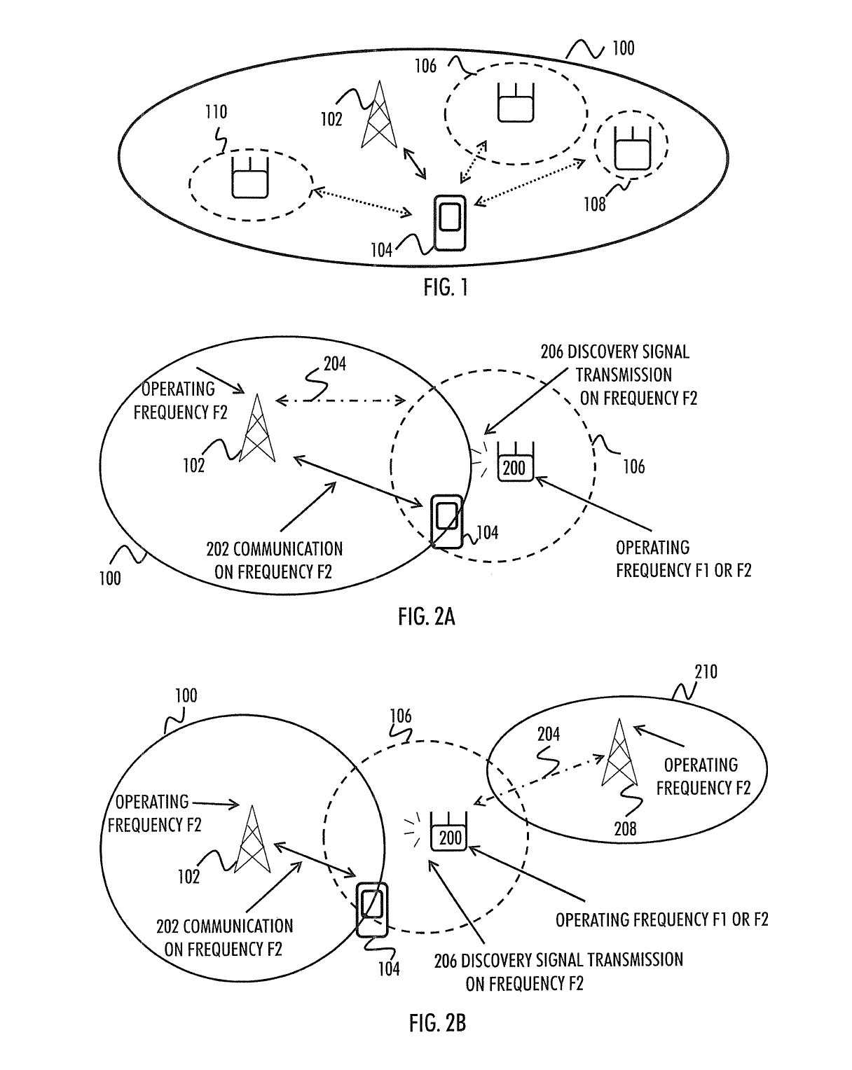

As shown in FIG. 1, In addition to a macro base station 102 providing coverage and controlling a macro cell 100, there may be local area (LA) cells 106 to 110 deployed in an overlapped manner within the macro cell 100, as shown in FIG. 1. Each local area cell or a “small” cell 106 and 110 may have a downlink receiver module, and therefore the small cell 106 to 110 may be able to initially or periodically operate in a Network Listen Mode (NLM). According to the measured signal strengths or other factors, the small cell 106 to 110 may select one macrocell from the detected macro cells as its associated cell, such as the macro cell 100. The associated cell 100 may have control over the small cell 106 to 110 to some degree. Each local area cell 106 to 110 may be a femto cell, a pico cell or a micro cell, for example.

The UE 104 may be connected to the macro cell 100 and more particularly to the macro base station 102 as shown with the solid arrow. Thus, the UE 104 may be referred to as a macro UE (MUE). However, the small cells 106 to 110 may be able to provide better communication performance for the MUE 104 than the macro base station 102. For example, a handover from the macro cell 100 to one of the small cells 106 to 110 may save the MUE's 104 power consumption and efficiently offload from macro to small cells. However, in order to perform the handover, the MUE 104 may first need to detect the presence of such small cell 106 to 110 in its proximity. Therefore, how to efficiently discover a small cell 106 to 110 in the vicinity of the MUE 104 is an issue.

There are some existing techniques for performing the detection. However, they either require extensive inter-frequency measurements by the UE 104, use extensive amount of resources, or lack coordination between the neighboring femto-cells 106 to 110, and consequently they may cause significant amount of interference and be energy inefficient. For example, not only may the discovery signals cause interference to the macro network, but also different discovery signals may interfere with each other.

Therefore, in order to at least partially solve the above mentioned problems, a discovery signal transmitting scheme for a small cell discovery based on the small cell 106 detecting at least one MUE 104 in its proximity and negotiating with the associated macro cell 100 is proposed. For the following, let us assume that the UE 104 is in the coverage area of the LA cell 106 while communicating (shown with a bi-directional arrow 202) with the macro cell 100, as shown in FIGS. 2A and 2B. FIGS. 2A and 2B differ in that the associated cell of the small cell 106 is different, as will be explained. Let us further assume that the macro cell 100, to which the UE is connected to, operates on frequency F2, whereas the operating frequency of the LA cell 106 may be either F2 or F1.

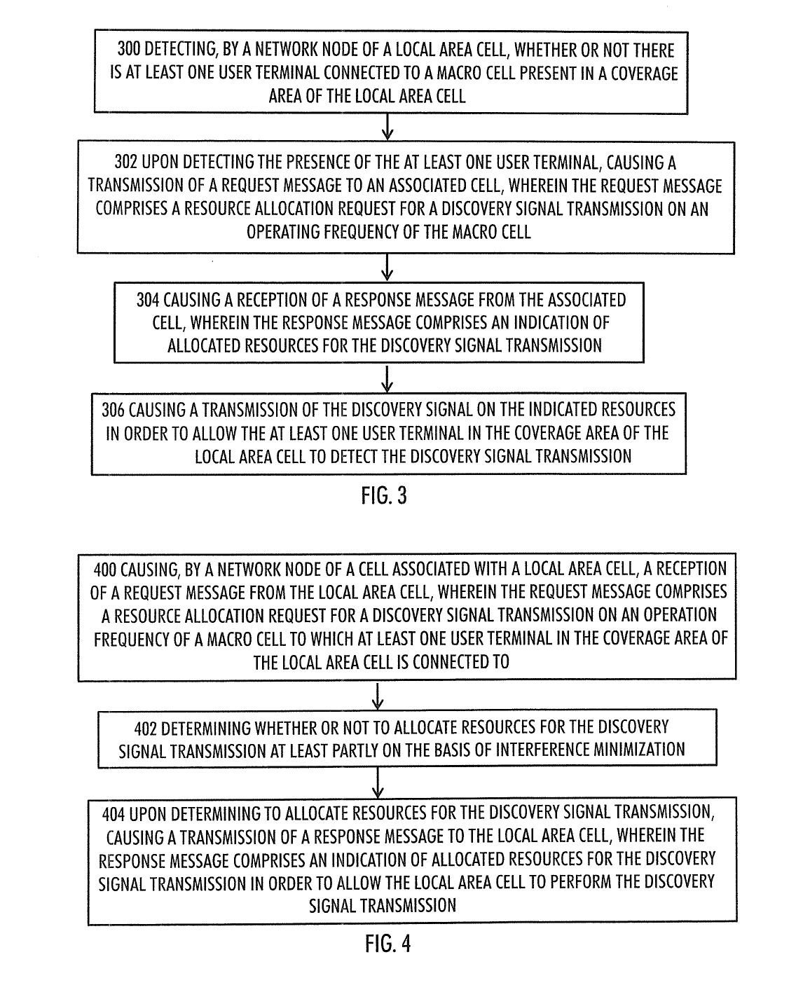

Then, the proposal comprises, as shown in FIG. 3 in step 300, the network node (such as a base station or an access point) 200 of the small cell 106 detecting whether or not there is at least one user terminal 104 connected to the macro cell 100 present in a coverage area of the local area cell 106. That is, whether there are any UEs 104 communicating with the macro cell 100 in the cell 106. This may be performed on the basis of a detection of UEs' uplink transmissions, for example, as will be described.

Upon detecting the presence of the at least one user terminal 104, the node 200 may transmit a request message to an associated cell 100 or 210 in step 302, wherein the request message comprises a resource allocation request for a discovery signal transmission 206 on an operating frequency F2 of the macro cell. 4. In other words, once the uplink detection shows the existence of active MUE 104, this event triggers the small cell 106 to request resources for the discovery signal transmission from the associated cell 100 or 210. This may be needed as the frequency of the to-be-performed discovery signal transmission is F2 which is the same as the operating frequency of the macro cell 100. In this way, the associated cell 100 or 210 may perform interference avoidance or mitigation when granting the resources, as will be discussed later.

Thereafter, the node 200 may receive, in step 304, a response message from the associated cell 100 or 210, wherein the response message comprises an indication of allocated resources for the discovery signal transmission 206. The node 200 may then, in step 306, cause a transmission of the discovery signal 206 on the indicated resources in order to allow the at least one user terminal 104 in the coverage area of the local area cell 106 to detect the discovery signal transmission 206, and thus, detect the small cell 106 in the vicinity. Based on the detection, the UE may trigger a handover to the small cell 106, if needed.

FIG. 4 depicts the proposal from the point of view of the associated cell 100 or 210 instead of the LA cell 106. The proposal comprises, in step 400, receiving the request message from the local area cell 106, wherein the request message comprises a resource allocation request for a discovery signal transmission 206 on an operation frequency F2 of the macro cell 100 to which at least one user terminal 104 in the coverage area of the LA cell 106 is connected to.

Thereafter, the associated cell (which may be the macro cell 100 or another macro cell 210) may determine whether or not to allocate resources for the discovery signal transmission 206 in step 402. This step may take into account the interference that may be caused to the macro cell 100 and to the other existing discovery signal transmission, as will be described.

Upon determining to allocate resources for the discovery signal transmission 206, the associated cell 100 or 210 may transmit, in step 404, the response message to the LA cell 106, wherein the response message comprises an indication of allocated resources for the discovery signal transmission 206 in order to allow the LA cell 106 to perform the discovery signal transmission 206. Such a network assisted solution for the discovery process of a small cell 106 may be beneficial because the network-assisted solutions do not put additional requirements on the existing UEs and may thus be backward compatible with legacy UEs.

As said, whether the small cell 106 is to transmit the discovery signal 206 to facilitate the small cell 106 discovery for the UE 104 depends on the results of the UE detection performed in step 400. This may be energy efficient because the small cell 106 may mute its transmission of the discovery signal for most of the time (when no UE is detected to be in the proximity) and this may also reduce the interference. Moreover, as a result, the small cell 106 in the vicinity of the UE 104 may be efficiently discovered without aggressive inter-frequency measurements by the UE 104.

Let us first take a closer look at FIG. 2A in which the associated cell is the macro cell 100. The association to a certain cell is represented in both FIGS. 2A and 2B with the dot-dashed line 204. Then the communication of the request message and the response message is between the base station 102 of the macro cell 100 and the base station 200 of the LA cell 106. However, when the associated cell is another macro cell 210 than the macro cell 100 to which the at least one user terminal 104 is connected to, the situation is different. Such may be the case, for example, if the LA cell 106 is located near the border between two macro cells 100 and 210, as shown in FIG. 2B. In such case, the associated cell 210 and the macro cell 100 may communicate over the X2 interface, if needed. The communication may comprise radio resource control management with respect to the resources for the discovery signal transmission 206, for example.

In an embodiment, the local area cell 106 operates on a same operating frequency F2 as the macro cell 100 to which the at least one user terminal 104 is connected to. The discovery signal may also be sent on the frequency F2 and the UE 104 may be able to detect the discovery signal broadcast 206 and, thus, detect the LA cell 106 in the vicinity. Then, the UE 104 may advantageously trigger a handover process from the macro cell 100 to the small cell 106, if needed.

Let us now consider an embodiment where the small cells 106 to 110 are operating with different operation frequency or frequencies F1 than the macro cell 100 to which the at least one user terminal 104 is connected to. Further, let us assume that the small cells are deployed in an uncoordinated way within the macro cell 100. In such scenario, the UT/UE 104 typically needs to carry out inter-frequency measurements frequently in order to discover the small cells 106 to 110 on non-serving carriers on frequency F1. Aggressive use of such inter-frequency measurements may unfortunately be costly in terms of the MUE's 104 power consumption. In addition, measurement gaps may occupy significant amount of resources.

However, the proposed solution may provide an efficient solution to this problem as well. As described above, according to the proposal, the UE 104 need not perform any inter-frequency measurements but the measurements may be made on the operating frequency F2. In such case the discovery signal 206 may be called an inter-frequency discovery signal. This is because the discovery signal 206 is transmitted on the frequency F2 even though the operating frequency of the small cell 106 is different, i.e. F1. In other words, regardless of whether the operating frequency of the LA cell 106 is F1 or F2, the discovery signal is transmitted on F2, which is the operating frequency of the macro cell 100.

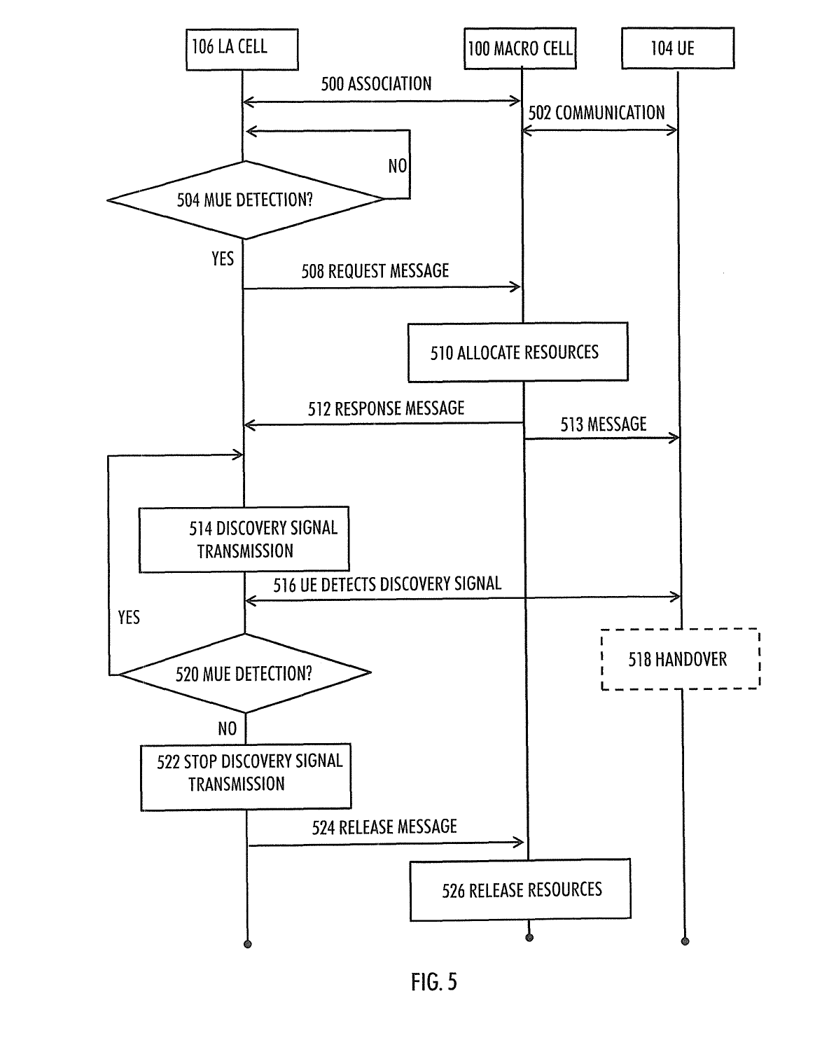

Now let us look at the signaling flow diagram as presented in FIG. 5. In step 500, when the small cell 106 is powered on or reset, it may go through an initialization process in which the small cell 106 finds its associated macro cell by applying the Network Listen Mode (NLM), for example. Let us for this example consider that the macro cell 100 is the associated cell for reason of simplicity. Further, it should be noted that in FIG. 5 only one small cell 106 is shown for the convenience of the description, but the method may be extended to any number of small cells.

In step 502, which may or may not precede the step 500, it is shown that the UE 104 communicates with the macro cell 100 on frequency F2. Let us, for the example of FIG. 5, consider that the operating frequency F2 of the macro cell 100 is different than the operating frequency F1 of the LA cell 106. That is, the discovery signals transmitted by the small cell 106 may be called inter-frequency discovery signals.

In step 504, the small cell 106 may first determine whether there are active UEs 104 connected to the macro cell 100 (i.e. macro UEs, MUEs) in the vicinity. The small cell 106 may determine whether there are active MUEs in the vicinity based on an uplink detection performed by the small cell 106. Two approaches, detection based on interference over thermal (IoT) and detection of uplink reference signals (UL RS) may be used for the detection of uplink transmissions of the MUE 104, for example. These techniques are known to a skilled person and not explained here in detail. In addition, a combination of these, or any other known technique may be applied in step 504.

If the MUE detection in step 504 shows that there are no MUEs in the coverage area of the local area cell 106 connected to the macro cell 100, the method re-enters the MUE detection block 504. There may a periodicity defined for re-detecting the presence of the MUEs in the local area cell 106, for example. This may be advantageous as there is no point in transmitting the discovery signal if there is no MUE that would receive the discovery signal transmission in the cell 106. However, if the uplink detection in step 504 shows existence of active MUEs 104 in the coverage area of the small cell 106, the method proceed to step 508.

In step 508, the small cell 106 may send the request message to the associated cell, which in this example is the macro cell 100. The request message may comprise a request for resource allocation, as explained. The request message may be sent to the associated macro cell 100 through a wired link or a wireless link between the small cell 106 and the macro cell 100 in order to inform the associated macrocell 100 that the small cell 106 has detected the MUE 104 and that the small cell 106 intends to transmit the (inter-frequency) discovery signal.

Further, in an embodiment, the request comprises at least one of the following: an indication of the identification of the local area cell 106 (such as a small cell ID), an indication of the location of the local area cell 106 (such as GPS coordinates), an indication of the neighbor cells of the local area cell 106, an indication of the presence of the user terminal 104 (such as a MUE existence indicator). The request may also comprise other information if needed.

In step 510, the associated macro cell 100 determines whether to allocate resource to the small cell 106 or not. When performing such determination, the base station 102 may, in an embodiment, take into account the previously allocated resources for other discovery signal transmissions by other local area cells (such as cells 108 and 110 in FIG. 1). This may be done in order to minimize interference between different discovery signal transmissions. Thus, the network is advantageously given some coordinated control over the small cells 106 to 110 located in its coverage area 100 to avoid or at least to mitigate interference. It may be noted that the interference may exist not only between different discovery signals from a plurality of small cells 106 to 110 but also between the small cell 106 and the macro cell 100. If the cell 100 decides that the planned discovery signal transmission would cause too severe interference, the cell 100 may not allocate any resources to the small cell 106. However, for the sake of the description, let us assume that the cell 100 does allocate resources.

The radio resources may refer to time slots or frequency slots, or codes, or other resources. For example, different small cells 106 to 110 may be allocated different frequencies inside the frequency band of the macro cell 100 (i.e. inside the operating frequency F2 of the macro cell 100). The resources may be selected advantageously so that the interference is minimized.

Thereafter, in step 512, after the base station 102 of the associated cell 100 has decided to allocate the resources, the associated cell 100 may transmit the response message to the small cell 106 to indicate the allocated resources for the discovery signal transmission. The message may include at least the allocated radio resources indicator.

In an embodiment, the response message further comprises a discovery pattern to be applied in the discovery signal transmission. The discovery pattern may be used to separate the discovery signal transmissions from different small cells 106 to 110. The discovery patterns may refer to mutually (quasi-) orthogonal sequences among small cells (e.g. CDM-based sequences). The discovery patterns may also be used to indicate that different discovery signals may occupy different resource elements within a downlink time-frequency grid (i.e. different sub-carrier shifted patterns and transmission interval). The discovery patterns may also include different blank radio resources (e.g. blank subframes) in the discovery signals from different small cells 106 to 110 for interference avoidance and energy efficiency. There may also be some other related information to grant the small cell 106 to transmit the discovery signal.

In an embodiment, the base station of the associated cell may further cause a transmission of information to the at least one user terminal 104 in step 513, wherein the information indicates the at least one user terminal 104 to perform measurements for the discovery signal transmission 206 on the allocated frequency F2. That is, when the associated macro cell base-station 102 sends the response message to the LA cell base station, the associated BS 102 may also broadcast a message to the UEs 104 that they may perform intra-band measurements for the discovery signal.

In step 514, the small cell 106 may then transmit the (inter-frequency) discovery signal on the allocated radio resources of frequency F2 while the applied resources advantageously minimize interference with other small cells 108 to 110 and with the macro cell 100. In an embodiment, the discovery signal comprises at least one of the following: information about the identification of the local area cell 106, the operation frequency F1 of the local area cell 106 instead of or in addition to the frequency F2 used to transmit the discovery signal.

In step 516, the UE 104 may detect the discovery signal transmission. Based on the detection, the UE 104 may detect that there is the small cell 106 present in the proximity and that a handover to the small cell 106 may be possible, as shown in step 518. Thereafter, the active MUE 104 may send a proximity indication to the serving macro cell 100 when the handover 518 is to be made.

In step 520, while transmitting the inter-frequency discovery signal, the small cell 106 may still make detection of uplink transmissions in order to determine whether there is any active MUEs 104 in the vicinity anymore. Upon detecting that there is at least one UT connected to the macro cell 100 (or some other macro cell) present in the coverage area of the local area cell 106, the small cell 106 may keep on broadcasting the discovery signal as shown in the Figure. However, upon detecting that there are no user terminals connected to the macro cell 100 present in the coverage area of the local area cell 106 anymore, the small cell 106 may suspend the discovery signal transmission, as shown with a block 522. Turning off the transmission of the inter-frequency discovery signal in step 522 may advantageously reduce interference and save energy.

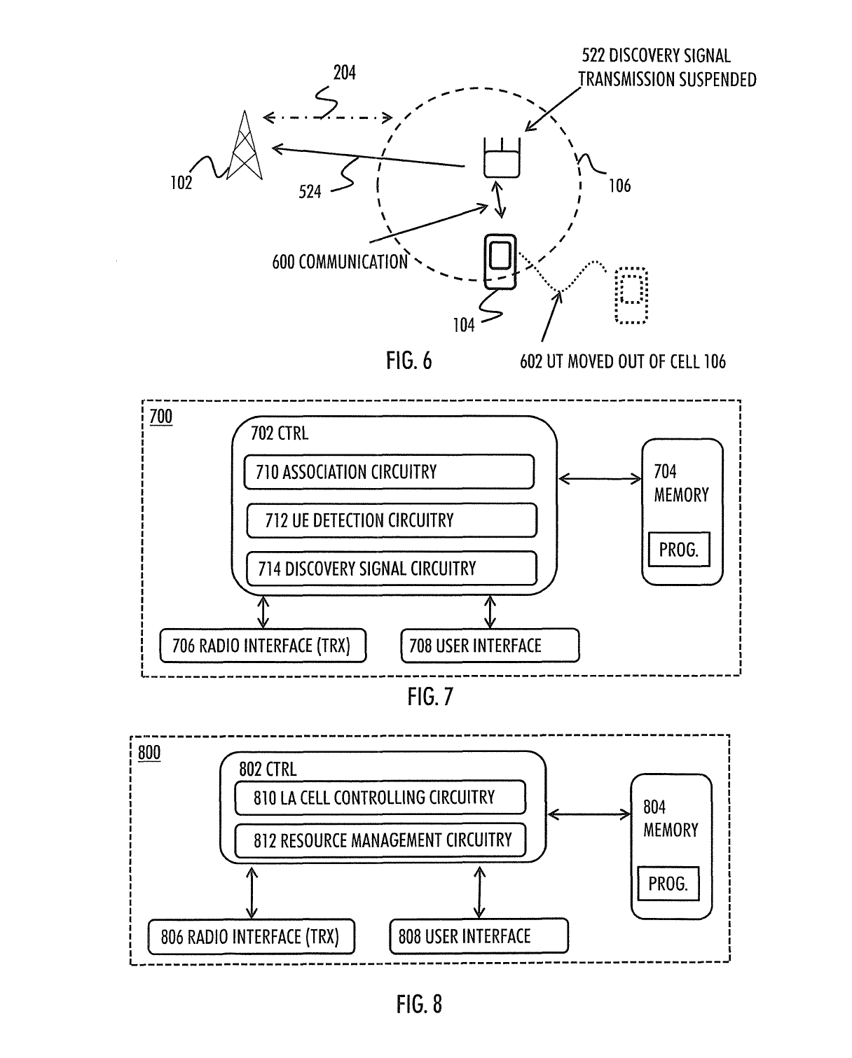

Further, when there is no user terminals present in the coverage area of the local area cell 106 anymore, the small cell 106 may transmit a release message to the associated cell 100 in step 524. This is shown in more details in FIG. 6. FIG. 6 shows that the small cell 106 has stopped broadcasting the discovery signal as shown with reference numeral 522. The suspension may be due to the uplink detection of the small cell 106 showing that all of the at least one active MUEs 104 in the vicinity has disappeared. The disappearance may be caused by the MUEs 104 leaving the coverage area of the small cell 106 (as shown with reference numeral 602) or due to a performed handover of the MUE 104 to the small cell 106 (as shown with reference numeral 600 representing the communication between the UE 104 and the small cell 106). As a result, the small cell 106 may transmit the release message to the associated macro cell 100 for notification in step 524.

In an embodiment, the release message 604 may comprise an indication that the allocated resources are no longer used for the discovery signal transmission in order to allow the associated cell 100 to release the resources for other purposes. The macro cell 100 may then receive the release message from the local area cell 106. Consequently the macro cell 100 may release the corresponding radio resources in step 526 of FIG. 5, which may then be used for other purposes. For example, the released resources may be allocated to other small cells 108 to 110 requesting to transmit such discovery signals.

FIGS. 7 and 8 provide apparatuses 700 and 800, each comprising a control circuitry (CTRL) 702, 802, such as at least one processor, and at least one memory 704, 804 including a computer program code (PROG), wherein the at least one memory 704, 804 and the computer program code (PROG), are configured, with the at least one processor 702, 802, to cause the apparatus 700, 800 to carry out any one of the described embodiments. It should be noted that FIGS. 7 and 8 show only the elements and functional entities required for understanding a processing systems. Other components have been omitted for reasons of simplicity. It is apparent to a person skilled in the art that the apparatuses may also comprise other functions and structures.

Each of the apparatuses 700, 800 may, as said, comprise a control circuitry 702, 802, respectively, e.g. a chip, a processor, a micro controller, or a combination of such circuitries causing the respective apparatus to perform any of the embodiments of the invention. Each control circuitry may be implemented with a separate digital signal processor provided with suitable software embedded on a computer readable medium, or with a separate logic circuit, such as an application specific integrated circuit (ASIC). Each of the control circuitries may comprise an interface, such as computer port, for providing communication capabilities. The respective memory 704, 804 may store software (PROG) executable by the corresponding at least one control circuitry

The apparatuses 700, 800 may further comprise radio interface components (TRX) 706, 806 providing the apparatus with radio communication capabilities with the radio access network, such as to the different macro cells, associated cells, small cells, as the case may be. The radio interface components may comprise standard well-known components such as amplifier, filter, frequency-converter, (de)modulator, and encoder/decoder circuitries and one or more antennas.

The apparatuses 700, 800 may also comprise user interfaces 708, 808 comprising, for example, at least one keypad, a microphone, a touch display, a display, a speaker, etc. Each user interface may be used to control the respective apparatus by the user.

As said, the apparatuses 700, 800 may comprise the memories 704, 804 connected to the respective control circuitry 702, 802. However, memory may also be integrated to the respective control circuitry and, thus, no memory may be required. The memory may be implemented using any suitable data storage technology, such as semiconductor based memory devices, flash memory, magnetic memory devices and systems, optical memory devices and systems, fixed memory and removable memory.

In an embodiment, the apparatus 700, 800 may be or be comprised in a base station (also called a base transceiver station, a Node B, a radio network controller, or an evolved Node B, for example). In an embodiment, the apparatus 700 is or is comprised in the base station of the small cell 106 to 110, such as the base station 200 of FIG. 2A and 2B. In an embodiment, the apparatus 800 is or is comprised in the base station of the associated macro cell 100/210, such as the base station 102/208.

The circuitry 702 of the apparatus 700 may comprise an association circuitry 710 for performing the selection of the associated macro cell. This circuitry may comprise, for example, a downlink receiver module configured to search and measure neighbor macro cell signals.

The circuitry 702 may further comprise a UE/UT detection circuitry 712 for detecting the presence of the macro UEs in the proximity. The circuitry 712 may comprise, for example, an uplink transmission detection module configured to determine whether there are active MUEs nearby the small cell.

The circuitry 702 may further comprise a discovery signal transmission circuitry 714 for broadcasting the discovery signal on the allocated resources on the frequency F2 of the macro cell to which the UE is connected to.

The circuitry 802 of the apparatus 800 may comprise a local area cell control circuitry 810 for controlling the associated LA cell. The circuitry 812 may further comprise a radio resource management circuitry 812 for allocating the radio resources on the basis of the request message from the small cell and handling the interference avoidance by taking into account the already allocated radio resources, for example.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
detecting, by a network node of a local area cell, whether or not there is at least one user terminal connected to a macro cell present in a coverage area of the local area cell;
upon detecting the presence of the at least one user terminal, causing a transmission of a request message to an associated cell, wherein the request message comprises a resource allocation request for a discovery signal transmission on an operating frequency of the macro cell;
causing a reception of a response message from the associated cell, wherein the response message comprises an indication of allocated resources for the discovery signal transmission; and
causing a transmission of the discovery signal on the indicated resources in order to allow the at least one user terminal in the coverage area of the local area cell to detect the discovery signal transmission.

2. The method of claim 1, wherein the local area cell operates on a different operating frequency than the macro cell to which the at least one user terminal is connected to.

3. The method of claim 1, wherein the local area cell operates on the same operating frequency as the macro cell to which the at least one user terminal is connected to.

4. The method of claim 1, wherein the associated cell is the macro cell to which the at least one user terminal is connected to.

5. The method of claim 1, wherein the associated cell is another macro cell than the macro cell to which the at least one user terminal is connected to.

6. The method of claim 1, wherein the request message further comprises at least one of the following: an indication of the identification of the local area cell, an indication of the location of the local area cell, an indication of the neighbor cells of the local area cell, an indication of the presence of the user terminal.

7. The method of claim 1, wherein the response message further comprises a discovery pattern to be applied in the discovery signal transmission.

8. (canceled)

9. The method of claim 1, further comprising:
upon detecting that there is no user terminal connected to the macro cell present in the coverage area of the local area cell anymore, suspending the discovery signal transmission; and
causing a transmission of a release message to the associated cell, wherein the release message comprises an indication that the allocated resources are no longer used for the discovery signal transmission in order to allow the associated cell to release the resources for other purposes.

10-13. (canceled)

14. An apparatus, comprising:
at least one processor and at least one memory including a computer program code, wherein the at least one memory and the computer program code are configured, with the at least one processor, to cause the apparatus at least to:
detect whether or not there is at least one user terminal connected to a macro cell present in a coverage area of a local area cell;
upon detecting the presence of the at least one user terminal, cause a transmission of a request message to an associated cell, wherein the request message comprises a resource allocation request for a discovery signal transmission on an operating frequency of the macro cell;
cause a reception of a response message from the associated cell, wherein the response message comprises an indication of allocated resources for the discovery signal transmission; and
cause a transmission of the discovery signal on the indicated resources in order to allow the at least one user terminal in the coverage area of the local area cell to detect the discovery signal transmission.

15. The apparatus of claim 14, wherein the local area cell operates on a different operating frequency than the macro cell to which the at least one user terminal is connected to.

16. The apparatus of claim 14, wherein the local area cell operates on the same operating frequency as the macro cell to which the at least one user terminal is connected to.

17. The apparatus of claim 14, wherein the associated cell is the macro cell to which the at least one user terminal is connected to.

18. The apparatus of claim 14, wherein the associated cell is another macro cell than the macro cell to which the at least one user terminal is connected to.

19. The apparatus of claim 14, wherein the request message further comprises at least one of the following: an indication of the identification of the local area cell an indication of the location of the local area cell, an indication of the neighbor cells of the local area cell, an indication of the presence of the user terminal.

20. The apparatus of claim 14, wherein the response message further comprises a discovery pattern to be applied in the discovery signal transmission.

21. (canceled)

22. The apparatus of claim 14, wherein the at least one memory and the computer program code are configured, with the at least one processor, to cause the apparatus further to:
upon detecting that there is no user terminal connected to the macro cell present in the coverage area of the local area cell anymore, suspend the discovery signal transmission; and
cause a transmission of a release message to the associated cell, wherein the release message comprises an indication that the allocated resources are no longer used for the discovery signal transmission in order to allow the associated cell to release the resources for other purposes.

23. An apparatus, comprising:
at least one processor and at least one memory including a computer program code, wherein the at least one memory and the computer program code are configured, with the at least one processor, to cause the apparatus at least to:
cause a reception of a request message from an associated local area cell, wherein the request message comprises a resource allocation request for a discovery signal transmission on an operation frequency of a macro cell to which at least one user terminal in the coverage area of the local area cell is connected to;
determine whether or not to allocate resources for the discovery signal transmission at least partly on the basis of interference minimization; and
upon determining to allocate resources for the discovery signal transmission, cause a transmission of a response message to the local area cell wherein the response message comprises an indication of allocated resources for the discovery signal transmission in order to allow the local area cell to perform the discovery signal transmission on the indicated resources.

24. The apparatus of claim 23, wherein the at least one memory and the computer program code are configured, with the at least one processor, to cause the apparatus further to:
take into account the previously allocated resources for other discovery signal transmissions by other local area cells when allocating resources for the current discovery signal transmission in order to minimize interference between different discovery signal transmissions.

25. The apparatus of claim 23, wherein the at least one memory and the computer program code are configured, with the at least one processor, to cause the apparatus further to:
cause a transmission of information to the at least one user terminal, wherein the information indicates the at least one user terminal to perform measurements for the discovery signal transmission on the allocated frequency.

26. The apparatus of claim 23, wherein the at least one memory and the computer program code are configured, with the at least one processor, to cause the apparatus further to:
cause a reception of a release message from the local area cell, wherein the release message comprises an indication that the allocated resources are no longer used for the discovery signal transmission and
release the allocated resources for other purposes.

27. (canceled)

28. (canceled)
